(19) United States
(12) Patent Application Publication
(10) Pub. No.: US 2007/0245420 A1
(43) Pub. Date: Oct. 18, 2007

(54) Method and system for user network behavioural based anomaly detection

(76) Inventors: Yuh Ming Yong, Richmond Hill (CA); Xiaodong Lin, Waterloo (CA)

Correspondence Address: Ralph A. Dowell of DOWELL & DOWELL P.C., 2111 Eisenhower Ave, Suite 406, Alexandria, VA, 22314, US

(21) Appl. No.: 11/644,993

(22) Filed: Dec. 26, 2006

(30) Foreign Application Priority Data
Dec. 23, 2005 (CA) 2531410

(51) Int. Cl. G08B 23/00

(52) U.S. Cl. 726/23

(57) ABSTRACT

A baseline can be defined using specific attributes of the network traffic. Using the established baseline, deviation can then be measured to detect anomaly on the network. The accuracy of the baseline is the most important criterion of any effective network anomaly detection technique. In a local area network (LAN) environment, the attributes change very frequently by many change agents; for example, new entities, such as users, application, and network-enabled devices, added to and removed from the LAN environment. The invention provides an improved method of establishing a baseline for network anomaly detection based on user's behaviour profiling. A user behaviour profiling is a distinct network usage pattern pertaining to a specific individual user operating on the LAN environment. No two users profiling would be the same. A group of users that have similar network usage attributes can be extrapolated using data mining technique to establish a group profiling baseline to detect network usage anomaly. By combining user and group profiling, a network anomaly detection system can measure subtle shift in network usage and as a result separate good user's network usage behaviour from the bad one. Using the said technique, a lower rate of false positives of network anomaly can be created that is suitable to operate in a highly dynamic LAN environment.

### FIELD OF THE INVENTION

The invention relates generally to monitoring network usage patterns, and more specifically to a method and system of detecting anomalies in network environments by monitoring user network behaviours.

### BACKGROUND OF THE INVENTION

The topic on the anomaly based intrusion detection has been extensively studied in the past decade and witnessed so many security breaches made headlines. In order to improve weaknesses of signature based intrusion detection system (IDS), the anomaly detection systems come into play since in 1987 when Dorothy Denning presents a model of how an anomaly detection system could be implemented. The anomaly detection systems fall into six major categories, depending upon the methods they use to learn baseline behaviours and identify deviations from those established baselines. The six main detection types include neural networks, statistical analysis, signal processing, graph, payload and protocol-based systems. However, anomaly detection system is frequently plagued by time-consuming false positives. One design consideration for anomaly detection is that LAN environment is highly dynamic and any number of things can change the network traffic patterns; for example, adding new services, adding new employees or adding new resources. Another design consideration is that network user habits are deterministic and once engrained, these habits are difficult to change. A more accurate and effective network anomaly detection system should be based on user behavioural profiling and assume the network environment is always dynamic and not static. These two attributes (i.e. dynamic LAN environment and deterministic human habits) are used to design a system that applies behavioural analysis to measure anomaly and deviation in how the network resources are used by the user.

### SUMMARY OF THE INVENTION

This invention applies behavioural analysis methods to establish individual user's set of network attributes baselines for measuring anomaly and deviation in the user's network usage on an internal local area network (LANs) that are behind firewalls at the network edge and DMZ. The said system in this invention deals with the complexity of LAN environment and network user's behaviour. The said system models these two attributes (i.e. dynamic LAN environment and complex network user's bebaviour) detect obvious, subtle, new, and unknown network anomalies often difficult to identify, distinguish, and differentiate in a highly dynamic LAN environment where constant changes of the network environment make it ineffective to use pre-defined network traffic patterns for detecting unknown, unforeseen, and new network attacks. The said system is deployed in an internal LANs environment and can be configured to sniff network packets either through SPAN port (ie port mirroring) or inline network tap. Both configurations duplicate a copy of a network packet to the said system. One or more network subnets/segments may be aggregated and have their network packets copy to the said system.

The said system uses the network packets to identify user and host on the LANs. A user is defined as one whose identity can be associated to a network resource used by that particular user. A host is defined as one which does not have an affiliation to a particular user. It is assumed that the network users and hosts on the LAN must have been authenticated before allowed access on the LAN or use any network services. Based on this assumption, the said system can trace the presence of network users and hosts on the LAN by interrogating the authentication server or installing a desktop software agent on the user's/host's machine to emit the presence information whenever the user/host is granted access to the network. The presence information is then correlated with the network IP address that is used by the network user/host. The said system can operate with both agent-based and agentless-based approaches to capture user's and host's identities automatically. Once user or host has been identified, the said system associates the network packets pertaining to a user or host and extract network usage attributes, from the network packets, to build a set of profiles of the user or host. By correlating presence and network information, a behavioural profiling can be established that uniquely reflect an individual user's/host's distinct network usage and network traffic patterns. A profile represents the behaviour of the user or host on the LAN, such as quantity and velocity of network connections, time of connectivity, direction of network packet flow, frequency and ratio of valid network packets, volume of network packets, length and size of network packets, etc. Each user and host has a set of profiles, which are various baselines that can be used to measure network behaviour deviation against learned/observed normal acceptable network behaviour. The baselines are a representation of accepted user's behaviour on the network that is learned by the said system over a period of time. The baselines can be learned and relearned continuously by the said system.

In addition to user and host profiles, a group profile can be defined by logically grouping network users who have similar or common network usage attributes (for example, a group of users who use certain types of network resources, or use a common point of entry into the networks via VPN wireless-LAN, a group of users belonging to a department, and etc.) Hence a group profile reflects the common behaviour of majority members in the group that are considered good network usage behaviour, based on the assumption that network security breaches are caused by a minority of network users on the LAN. The application of a group profile can effectively separate a particular “bad” behaviour from a collective “acceptable” behaviour.

The said system is composed of the following four components:
1. User presence detection—this is used to track where a user is connected to the network.
2. User, host and group profilings—this is used to build set of baselines for detecting network usage abnormality.
3. Behavioural deviation detection engine—this is used to identify deviations from the learned and observed historical network usage behavioural patterns.
4. Graphical User Interface (GUI)—this is used by an administrator to view, examine, and reporting on the events captured by the said system.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1 is a diagram illustrating the components of a anomaly detection system;

FIG. 2 is a block diagram illustrating the components of the analysis server;

FIG. 3 is a flowchart illustrating the steps of an auto user presence detection method

FIG. 4 is an example illustrating how Identity Aggregate Module works

FIG. 5 is a flowchart illustrating the steps of user and group profiling method

FIG. 6 is an example illustrating visited HTTP service usage

FIG. 7 is a flowchart illustrating the steps of an anomaly detection method

### DETAILED DESCRIPTION OF THE INVENTION

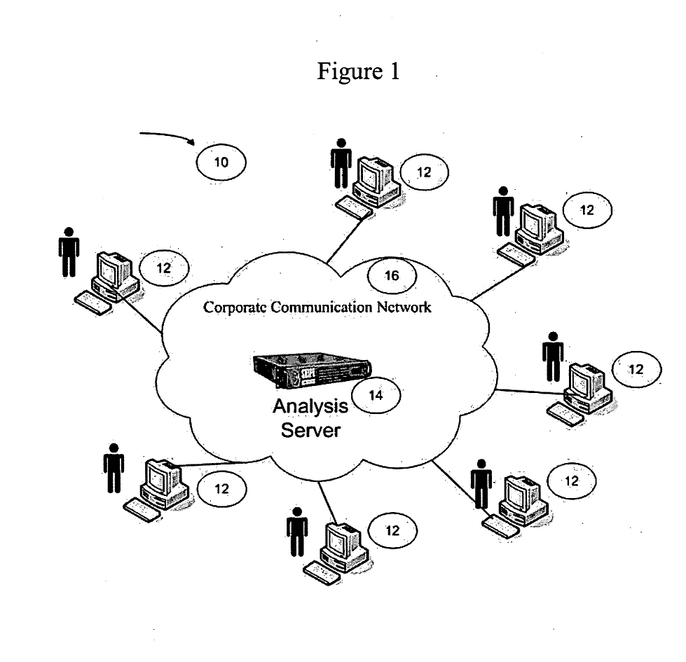

Reference is now made to FIG. 1, where the components of the anomaly detection system 10 are shown in an exemplary embodiment. The detection system 10 is comprised of one or more computing stations 12 that communicate with an analysis server 14 through a corporate communication network 16. The detection system 10 in an exemplary embodiment is used to profile user behaviour in relation to the use of one or more computing stations 12 that are part of the system 10. By profiling user behaviour and group behaviour, as explained below, usage changes associated with a user can be detected and can then be used to determine whether any anomalies exist in a network (where the system 10 is part of a network).

The computing stations 12 may be any devices that can communicate with a communication network 16, and may include, but are not limited to, desktop computers, slimline computers, server computers, handheld computers, and any other computing devices that can communicate with a corporate communication network 16 via wired or wireless communication medium. The network packets generated by the computing stations 12 are captured by network devices (not shown within the corporate communication network 16), using SPAN port configurable by software and hardware-based network tap, and duplicated and sent to the analysis server 14.

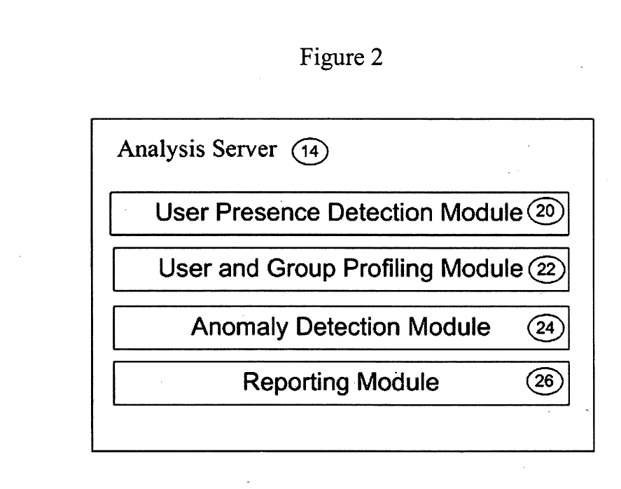

The analysis server 14, is further described with respect to FIG. 2, and is used to detect the presence of users through one or more ways. Specifically, the analysis server may receive user presence information from an authentication server (not shown) which may be a server type computer which regulates access to the network and any associated devices that are part of the network. Alternatively, the server may receive information from software agents that are installed on the computing stations 12. The software agent can be installed manually by the user and scheduled push installation. Once it is installed, the software agent is started at system boot and runs as a service. The software agent detects activities such as user-invoked log-on, user-invoked log-off, system-invoke time-out and screen-lock. These activities will trigger the software agent to transmit the present information to the analysis server 14. The software agents would gather user information containing user identity and IP addresses of used computing stations 12. The user identity may consist of a combination of identifiers that are gathered to uniquely associate with the user. Examples of user identifiers include, but are not limited to a user's network log-on identification and (host) name of the computing stations 12. Also, the analysis server 14 may detect the presence of users through engaging in analysis or sniffing of the network traffic, which may be referred to as auto user presence detection. By analysis or sniffing of the network traffic data, the analysis server 14 may then decode the protocols that contain user information. The analysis server 14 also allows for user and group profiling, and anomaly detection as described below.

The corporate communication network 16 may be any network that allows for the exchange of data, and may be a combination of a wired or wireless network, and may include, but is not limited to, a local area network. For example, an Ethernet LAN. The corporate communication network 16 resides behind the firewall of the DMZ (Demilitarized Zone in Computer Networking, and network edge). The corporate communication network 16 may be partitioned into one or more network segments that are controlled by one or more network switches. One analysis server 14 may monitor one or more network segments. One analysis server 14 may be designated as the central analysis server to manage and control multiple node analysis servers 14 that are deployed across the entire corporate communication network 16. The central analysis server is termed the “Controller” and the node analysis server is termed the “Sensor”. The “Sensor” performs the task of sniffing network packets, decoding the networks packets, and summarizing the network packets. Afterwards, the “Sensor” sends those summarized information to the “Controller” by syslog. The data transfer method via syslog between analysis servers 14, specifically between one “Controller” and multiple “Sensors” is not only to reduce workload of the “Controller”, but also centralizes network information on the “Controller”. The “Controller” receives syslogs from the various “Sensors”, processes the syslogs, and stores the data into a database.

Reference is now made to FIG. 2, where the components of the analysis server 14 are shown in an exemplary embodiment. The analysis server 14 has associated with it a user detection module 20, a user and group profiling module 22, an anomaly detection module 24, and a reporting module 26. The user presence detection module 20 is used to track where a user is connected to the corporate communication network 16. User and group profiling module 22 is used to build a user and group profiling database (not shown) based on the information collected from a network access authentication system and network devices (not shown), such as network switch and network tap. The anomaly detection module 24 is used to identify network behavioural deviations from the established user and group profiling data (i.e. baseline or normal behaviour). The Reporting module 26 is used to monitor events and alerts and manage the detection engine by the administrators.

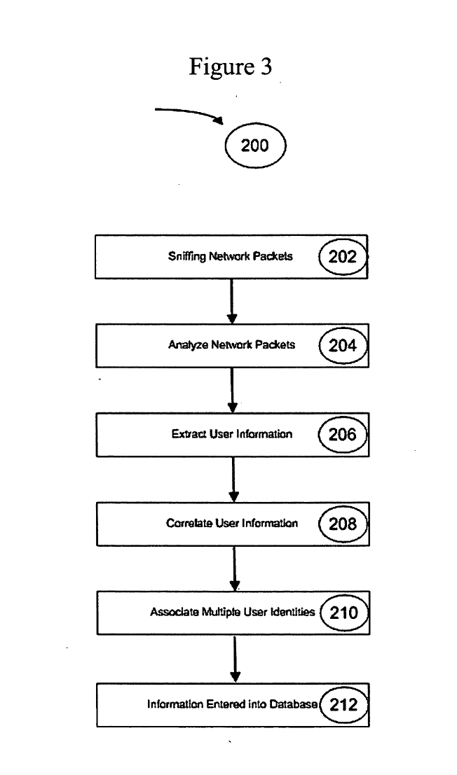

Reference is now made to FIG. 3, where the steps of an auto user presence detection method 200 are shown. The auto user presence detection method 200 is used to automatically discover the user's and host's network identity information by only sniffing and analyzing network packets—i.e. without necessarily install a desktop agent software on the user's computer. Auto user presence detection, method 200, in an exemplary embodiment begins at step 202, where the analysis server 14 sniffs the network packets using a network packet capture library, such as pcap, libpcap, etc. At step 202, by using a network packet capture library, the analysis server 14 captures packets from the network card directly. The analysis server 12 is installed with one or multiple network cards, operating at Mega or Giga bps, to capture and process the network packets. At step 204, the network packets are decoded to identify the protocol that contains the clear-text user information. Specifically, protocols including DNS, DHCP, NetBIOS, Microsoft Windows domain authentication (Kerberos), POP3, SMTP, IMAP, and propertiary desktop agent software. First, the relevant network packet is decoded to obtain the ethernet header, IP header, and TCP header. From the various headers, the source IP address, destination IP address, source port, and destination port information are obtained. Then, based on the protocol's port number (for example, the port number typically used by protocol POP3 is 110), the specific protocol analyzer is used to extract the user information. In step 206, the various user identities are extracted from the user information encoded in the protocol-specific network packet. The analysis server 14 implements various Extract User Information step 206 to extract user information from the various protocol-specific network packets that consist of clear-text user information. There is one Extract User Information step 206 for each protocol-specific authentication method. For example, if the analysis server 14 is decoding a SMTP network packet, then the user information as represented in the format of email address will be obtained. If only the IP address can be obtained, then the IP address is assigned as the user information of the computing station 12. If only the host name and the IP address can be obtained, then the hostname is assigned as the user information of the computing station 12. If username and the IP address can be obtained, then the username is assigned as the user information of the computing station 12. In order to eliminate incorrect user identification, the step 208 correlates the user information with the authentication status reported in the protocol that requires authentication, such as POP3, SMTP, IMAP4 and Kerberos. Furthermore, because a person may have multiple identities (for example, one corporate email account, one VPN account, multiple personal email accounts, etc), the step 210 is used to associate multiple users' identities with the rightful person, and aggregate multiple users' identities into one single identity representing a network user. At step 212, the user information is inserted into the analysis server's database.

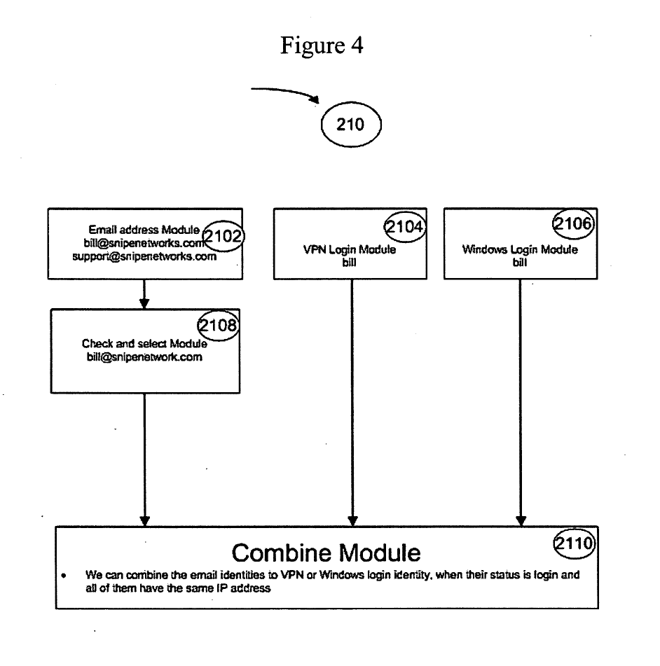

Reference is now made to FIG. 4, where the components of Identity Aggregate Module 210 are shown in an exemplary embodiment. Email address module 2102 parses email identity. However, it may obtain multiple email identities from a same IP address almost in the same time (for example, in one minute). Then, Check and select Module 2108 selects one of these email identities as the primary identity based on the following scenarios: 1). By analyzing the identity names, the one which is more similar to the host name of the used machine will be considered as the identity of this user; 2). The identity which has already been used by another IP or host name will be not considered as the identity of this user; 3). The one which has the name such as support, admin, administrator, root, etc., will not be considered as the identity of this user. Then we have one email identity of these email identities as the identity of this user, other email addresses will be discarded. VPN Login Module 2104 parses events from VPN log sent by VPN server. Windows Login Module 2106 parses user Windows account name. Combine Module 2110 combines the email identities to VPN or Windows login identity, when their status is login and all of them have the same IP address.

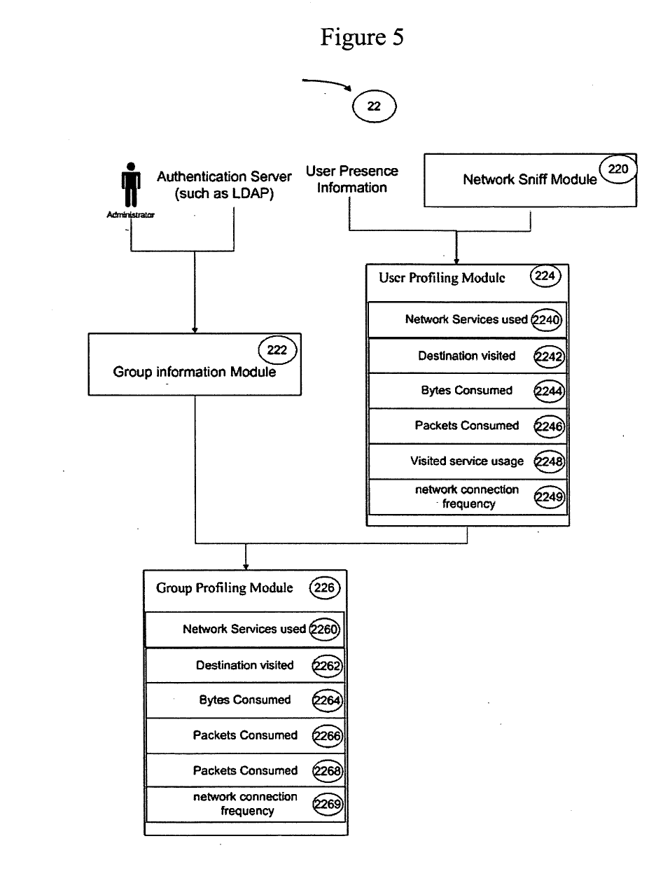

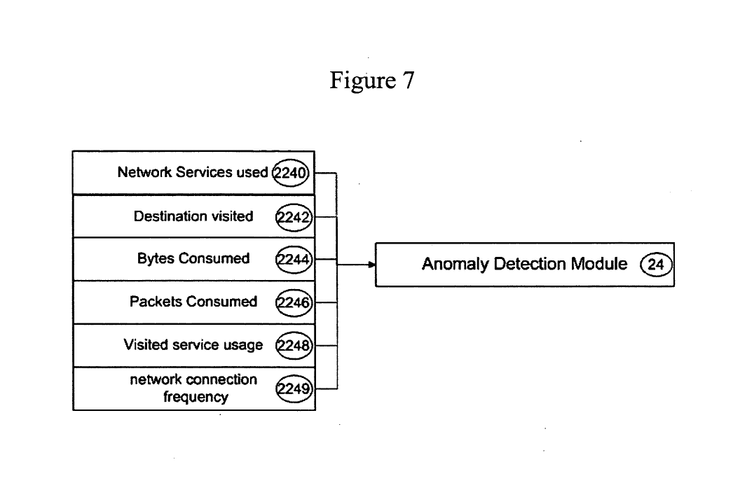

Reference is now made to FIG. 5, where a flowchart illustrating the steps of a User and Group Profiling module are shown. Given the user's presence information, the said system could obtain the network packets through various methods to build the user and group profiling by Network Sniff Module 220. Some of the methods are (1) proprietary and standard-based network packets collection protocols such as NetFlow, sFlow, jFlow, and cFlow, (2) network TAP, and (3) SPAN port. By aggregating information from user presence information and Network Sniff Module 220, User Profiling Module 224 builds the profiling of a user's network activities including, but not limited to, such as network services used 2240, Destination Visited 2242, Bytes Consumed 2244, Packets Consumed 2246, Visited service usage 2248, and network connection frequency 2249. User Group Information Module 222 can either collect group information from an authentication server, such as LDAP, or be entered by an administrator manually. By aggregating information from user group information and User profiling, Group Profiling Module 226 builds the profiling of a group of users' network activities including, but not limited to, such as network services used 2260, Destination Visited 2262, Bytes Consumed 2264, Packets Consumed 2266, Visited service usage 2268, and network connection frequency 2269. A threshold level can be defined for each level of acceptable risk. When a deviation exceeds the pre-defined threshold, an alert is generated to record and notify the breach. Based on the alert generated, the Anomaly Detection Module 24 (shown in FIG. 7) performs further analysis to (A) correlate the deviation against known exploits (through known vulnerable network services), and (B) correlate the deviation with other anomaly behaviour to detect unknown and new threats.

Network Services used 2240 is calculated by measuring the average network service used and its standard deviation over a predefined period of time, for example, two weeks. The Network Services 2240 behaviour anomaly model can be used to detect spyware using unknown network services for communication with un-trusted system.

Destination Visited 2242 is calculated by measuring the average destination visited and its standard deviation over a predefined period of time, for example, two weeks. The Destination Visited 2242 behaviour anomaly model can be used to differentiate two types of attackes—“within” and “outbound”. For a “within” attack, a higher ratio of internal IP addresses of destination visited would be targeted. An example of such attack may be network probe. For an “outbound” attack, a higher ratio of external IP addresses of destination visited would be targeted. An example of such attack may be malware using the compromised host for sending spam, transmiting data, generating unauthorized network traffic, and etc.

Bytes Consumed 2244 is calculated by measuring the average bytes consumed and its standard deviation over a predefined period of time, for example, two weeks. The Bytes Consumed 2244 behaviour anomaly model can be used to detect burst of activity that exceeds or defies acceptable risk level.

Packets Consumed 2246 is calculated by measuring the average packets consumed and its standard deviation over a predefined period of time, for example, two weeks. Trend analysis, using simple moving average and exponential moving average, is also used to spot behavioural shift, even though the deviation is within acceptable risk threshold. Ratio of packet types are also calculated to measure abnormality in packet consumption. The Packet Consumed 2246 behaviour anomaly model can be used to detect subtle behavioural shift.

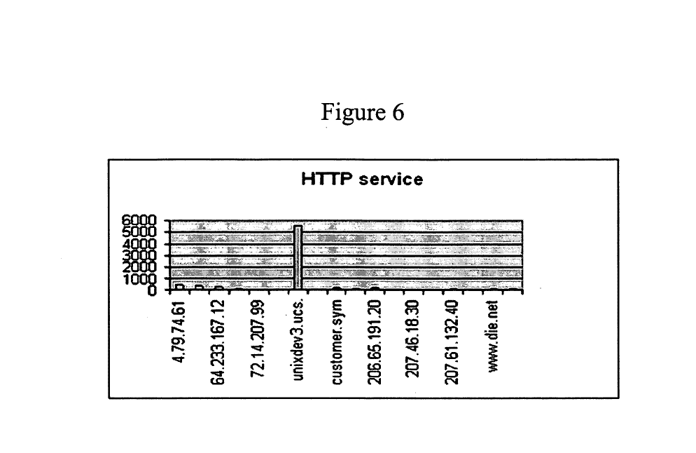

Suppose the network services usage of a particular user is represented in the form of a histogram. The X-axis represents the network services visited and the Y-axis represents the number of network packets generated using the network services. Using the histogram as a probability distribution, the analysis server 14 calculates the entropy (which is a measurement of the degree of dispersion of a distribution) to evaluate any shifts in user behaviour, which are shown as in FIGS. 6. An entropy is calculated for each network service consumed by the user, and is recorded as one of his normal network activities. All entropies are normalized to provide a faster evaluation of anomalous score and to decide whether or not there are behavioural anomalies by comparing against the established baseline.

Visited service usage 2268 is calculated by measuring the average entropies and its standard deviation over a predefined period of time, for example, two weeks.

Network connection frequency 2269 is calculated by measuring the average network connection frequency and its standard deviation over a predefined period of time, for example, two weeks.

Group Profiling Module 2260 analyzes all the common network activities among a set of users to derive group profiles. All group profiling is calculated by measuring the average and its standard deviation over a predefined period of time among the group of users.

Reference is now made to FIG. 7, which is an illustration of anomaly Detection Module 24, are shown. The user and group profiling data could become input of any machine learning algorithms, such as ANN (Artificial Neural Network), SVM (Support Vector Machines), Decision tree, and create a detection engine and increase the accuracy of anomaly intrusion detection. For example, the heuristic decision tree algorithm can be used to detect behavioural anomaly. Specifically, a user's bytes consumed profile exceeded the deviation threshold and the service used was TCP 9100, then the behavioural anomaly might be printer abuse. However, suppose the deviation threshold was triggered by visited service usage profile, then the behavioural anomaly might be a scan for network vulnerability.

Reporting module 26 is used for analysis using a variety of graphical and text reports to notify an administrator what is going on in the corporate network and how the user uses the network.

The inventions have been described by reference to exemplary embodiments, but many additions, modifications, and/or deletions can be made thereto without departing from the spirit and scope of the inventions. In other words, the particular embodiments of the inventions described herein are merely illustrative and are not the only embodiments possible. Those skilled in the art can readily identify additional embodiments and features of the inventions that are within the spirit and scope of the inventions.

1. In a LAN environment, the network traffic is highly dynamic and the operating attributes changes frequently. The said system applies profiling of user's network behaviour to define a baseline that is subsequently used to detect anomalous network usage and malicious network behaviour.

2. The user profiling recited in claim 1 correlates user presence with network usage information to link the identity of a network user to his network usage patterns. The said user presence information includes user's login information, network IP address assigned to the user's host machine, and user host machine's network MAC address. The said network usage information includes IP address of network service, network protocol, entry point of network service, and type of network service.

3. The user presence information recited in claim 2 can be obtained from an authentication system that allow or deny network access and maintains a database of user authentication data, such as Unix, Microsoft Windows domain controller and active directory, RADIUS, Microsoft Network Access Protection (NAP), Cisco Network Admission Control (NAC), 802.1x, and any authentication systems that exhibit such attributes of network access control and authentication data management.

4. The user presence information recited in claim 2 can be obtained by a way of sniffing network traffic and then decoding any protocol in clear-text format, which contains user information, for example, DNS, DHCP, NBNS, NetToken, Windows Domain Login and Email Login traffic.

5. It is highly like that a person has multiple identities, and an efficient and accurate algorithm of aggregating multiple identities into one person has been presented, which is described as follows: we combine multiple identities, such as email identities, VPN and/or Windows login identity, when their status is successful login and all of them have the same IP address. Furthermore, if more than one email identity are found almost in the same time (for example, in one minute) with a same IP, the following actions will be performed: (A) By analyzing the identity names, the one which is more similar to the host name of the used machine will be considered as the identity of this user. (B) The identity which has already been used by another IP or host name will be not considered as the identity of this user. (C) The one which has the name such as support, admin, administrator, root, etc., will not be considered as the identity of this user. Then we have one email identity of these email identities as the identity of this user, other email addresses will be discarded.

6. The network usage information recited in claim 2 can be obtained by sniffing network packets via passive network Tap device, SPAN port of managed switches, and NetFlow, sFlow, jFlow, and cFlow data of vendor-specific network devices.

7. A collection of the said user profiling as recited in claim 2 can be used to define a group profiling. The group profiling consists of a set of users who exhibit similar operating attributes in the LAN environment. The said attributes can be categorized by the user's roles and responsibilities in an organization. For example, employees in the R&D organization.

8. The set of users in a group profiling as recited in claim 5 could be defined by system administrators or imported from an authentication system (for example, a Windows domain controller).

9. The group profiling as recited in claim 5 is used to establish a baseline of common behaviour of a group of users. The said baseline is derived using data mining technique and it is then used to detect network usage anomaly. The said group profiling represents normalized good behaviour of a group of users based on the assumption that the majority of members in a group would exhibit good network usage behaviour.

10. The group profiling recited in claim 5 is also used to reduce the effect of baseline shift due to behaviour changes by a small subset of users within the group. The group profiling reflects the common behaviour of majority members in a group, which can be considered as good behaviour since it is usually true that violators are just minority users in the LAN environment and majority of the users have normal acceptable network behaviour.

11. The said system also considers the use case that user's network behaviour does change, although not too frequent. If a user's network behaviour deviates too far off from the individual's user profiling baseline and similar deviation also exhibit in other users in the same group, then the anomaly will be feedback to the said system as newly discovered normal user behaviour. The said feedback would result in re-establishing the user and group profiling baselines.

12. The said system would detect a collective shift in network behaviour as recited in claim 9 and re-establish the user and group baselines. The said collective shift in network behaviour would exhibit similar changes in behaviour by the majority users in the same group profiling.

13. The newly discovered normal behaviour as recited in claim 9 will be appended into the user and group profilings.

14. The said system that applies user and group profiling to monitor normal network usage allows security policy to be enforced at the user level.
